(19) United States
(12) Patent Application Publication
(10) Pub. No.: US 2024/0250354 A1
(43) Pub. Date: Jul. 25, 2024

(54) Battery Cell

(71) Applicant: Bayerische Motoren Werke Aktiengesellschaft, Muenchen (DE)

(72) Inventors: Franz FUCHS, Muenchen (DE); Kevin GALLAGHER, Naperville, IL (US); Martin HILLER, Karlsfeld (DE); Frederik MORGENSTERN, San Francisco, CA (US); Seokyoon YOO, Muenchen (DE)

(21) Appl. No.: 18/564,133

(22) PCT Filed: May 13, 2022
(86) PCT No.: PCT/EP2022/063057

§ 371 Date: Nov. 27, 2023

(30) Foreign Application Priority Data
May 28, 2021 (DE) 10 2021 113 876.0

(51) Int. Cl. H01M 50/179; H01M 50/107; H01M 50/152; H01M 50/186; H01M 50/30; H01M 50/531; H01M 50/55; H01M 50/559; H01M 50/627

(52) U.S. Cl. CPC H01M 50/179; H01M 50/107; H01M 50/152; H01M 50/186; H01M 50/30; H01M 50/531; H01M 50/55; H01M 50/559; H01M 50/627

(57) ABSTRACT

A battery cell is provided. The battery cell includes an electrode of a first electrical polarity and an electrode of a second electrical polarity opposite to the first polarity, the electrodes of different polarities are separated by a separator; a first electrically conductive contact element which is electrically connected to the electrode of the first polarity and can be contacted as a first terminal of the battery cell from outside the cell housing; a second electrically conductive contact element which is connected to the electrode of the second polarity and can be contacted as a second terminal of the battery cell from outside the cell housing; and the first and the second electrically conductive contact element are electrically insulated from each other and, on a same first end wall of the electrically conductive hollow cylinder, can each be contacted as a respective terminal from outside the cell housing.

### BACKGROUND AND SUMMARY

The present invention relates to a battery cell.

In the field of battery cells, in particular, cylindrical lithium-ion battery cells are known. In cylindrical battery cells, for example, electric power can be tapped-off from the exterior, wherein electrodes of one polarity are electrically connected to an electrically conductive cylindrical housing of the battery cell, such that the housing forms a first pole, and electrodes of the other and opposing polarity are electrically connected to a component which is electrically insulated from the housing, which projects from the interior of the battery cell through the cell housing wall, is electrically insulated from the latter and can be electrically contact-connected, as the second pole, from the exterior of the cell housing. It is known that different electrical polarities are tapped-off from opposing end faces of the housing of the battery cell. To this end, it is necessary for respective electrodes of the same polarity to be connected to the terminal which is assigned to this polarity at an end face of the housing. A current path is routed through the housing accordingly.

The object of the present invention is to provide a cylindrical battery cell having an improved facility for electrical contact-connection.

This object is achieved in accordance with embodiments of the independent claim(s). Various embodiments and further developments of the invention are the subject matter of the dependent claims.

The invention relates to a battery cell including: an electrode of a first electrical polarity and an electrode of a second electrical polarity, which is opposite to the first polarity, wherein electrodes of different polarities are mutually separated by a separator; a first electrically conductive contact element which is electrically connected to the electrode of the first polarity, and which can be contact-connected as a first pole of the battery cell from the exterior of the cell housing; a second electrically conductive contact element which is electrically connected to the electrode of the second polarity, and which can be contact-connected as a second pole of the battery cell from the exterior of the cell housing; wherein the first and second electrically conductive contact elements are electrically insulated from one another and, on a same first end face of the electrically conductive hollow cylinder, can each be contact-connected as a respective pole from the exterior of the cell housing.

In particular, the electrode of the first polarity can comprise aluminum, and can be configured as an electrically positive electrode. A first active material can be arranged on the electrode of the first polarity. In particular, the electrode of the second polarity can comprise copper, and can be configured as an electrically negative electrode. A second active material can be arranged on the electrode of the second polarity.

In the battery cell according to the invention, the electric voltage which is delivered by the latter between the two poles can be tapped-off at the same end face of the hollow cylinder. As a result, in particular, the current path through the wall of the hollow cylinder can also be significantly shortened, if not omitted. In particular, a shorter current path reduces electrical resistance.

The terms “incorporates”, “contains”, “includes”, “comprises”, “has”, “having”, which are optionally employed herein, or any other variant thereof, are intended to express a non-exclusive inclusion. Thus, for example, a method or a device which comprises or contains a list of elements is not necessarily restricted to these elements, but can also include other elements which are not expressly described, or which are inherent to a method of this type or to a device of this type.

Moreover, the term “or”, unless expressly indicated to the contrary, indicates an inclusive “or” rather than an exclusive “or”. For example, a condition A or B is met by one of the following conditions: A is met (or applicable) and B is unmet (or not applicable), A is unmet (or not applicable), and B is met (or applicable), and both A and B are met (or applicable).

The terms “a” or “an”, as employed herein, are defined in the sense of “one/one or more”. The terms “another” and “one further”, and any other variant thereof, are to be understood in the sense of “at least one further”.

“Electrical conductivity”, within the meaning of the invention, in particular, is to be understood as a physical variable, which indicates the magnitude of the capability of a material to conduct electric current. Accordingly, within the meaning of the invention, the term “electrically conductive” is particularly to be understood as indicative of an electrical conductivity of at least 106 S/m (at 25° C.), i.e., at least corresponding to the conductivity of metals.

“Electrical insulation”, within the meaning of the invention, in particular, is to be understood as a physical variable, which indicates the magnitude of the capability of a material which is arranged between two components, which respectively carry an electric current flux, to reduce or inhibit a current flux between said components which respectively carry an electric current flux.

Preferred embodiments of the device are described hereinafter, each of which, unless expressly excluded or technically unfeasible, can be mutually combined in an arbitrary manner, or combined with any further aspects of the invention which are described herein.

In some embodiments, electrical insulation between the first and second electrically conductive contact elements is configured by means of a radial spacing between the first and second electrically conductive contact elements, with respect to an axis of symmetry of the hollow cylinder. A radial spacing can be advantageous, as electrical insulation can be executed by means of spacing, with no additional insulating component.

In some embodiments, in the interspace formed by a radial spacing, a spacer element is arranged, which comprises an electrically insulating material. A spacer element can advantageously permit the achievement of a more effective electrical insulation, in comparison with spacing in the absence of a spacer element. Moreover, by means of a spacer element, it can be ensured that, in the event of a movement of the battery cell, which can potentially result in a movement of the first and/or second electrically conductive contact elements, the spacer element can prevent any contact between the contact elements, as a result of which a potential short-circuit can be prevented.

In some embodiments, the battery cell comprises an electrically insulating fastening element, to which the first and second electrically conductive contact elements are fastened, wherein the electrically insulating fastening element is arranged between the first end face of the electrically conductive hollow cylinder and the two electrically conductive contact elements. By the fastening of the first and second contact elements to a fastening element, the position of contact elements relative to one another can be fixed.

In some embodiments, the battery cell comprises an electrically conductive first closure plate, which closes the hollow cylinder at its first end face, wherein the first closure plate is electrically connected to the first electrically conductive contact element. Via the closure plate, the electrical polarity which corresponds to the first contact element can be tapped-off.

In some embodiments, the battery cell comprises an electrically conductive first closure plate, which closes the hollow cylinder at its first end face, having a first opening, in which a first electrically conductive adapter is arranged, such that it can be electrically contact-connected from the exterior of the cell housing, wherein the first electrically conductive adapter is electrically connected to the first electrically conductive contact element, and wherein the first electrically conductive adapter is electrically insulated from the first closure plate. As a result, an electrical connection to an electrode of a first polarity can be electrically formed from the exterior of the battery cell by means of an adapter. During the manufacture of the battery cell, the adapter can be connected to the closure plate, externally to the cell housing. The electrical connection of the adapter to the first electrically conductive contact element can be executed from the exterior of the cell housing, if the closure plate is already fitted to the hollow cylinder. It can thus be prevented that any contaminant particles which might be generated by the formation of electrical connections, for example by a welding process, enter the cell housing.

In some embodiments, the second electrically conductive contact element is electrically connected to the electrically conductive hollow cylinder. The electrode of the second polarity can thus be electrically contact-connected via the hollow cylinder.

In some embodiments, the second electrically conductive contact element is directly electrically connected to the electrically conductive first closure plate. As a result, a direct connection is permitted between the second contact element and the first closure plate, without an additional adapter, which might increase the electrical resistance of the overall connection between the electrode and the first closure plate.

In some embodiments, the electrically conductive first closure plate comprises a second opening, in which a second electrically conductive adapter is arranged, such that it can be electrically contact-connected from the exterior of the cell housing, wherein the second electrically conductive adapter is electrically connected to the second electrically conductive contact element, and wherein the second electrically conductive adapter is electrically insulated from the first closure plate. As a result, electric power can be tapped-off from the battery cell via the two adapters, which are arranged on the same end face of the hollow cylinder. During the manufacture of the battery cell, the two adapters can be connected to the closure plate, externally to the cell housing. The electrical connection of the adapters to the first or second electrically conductive contact element can be executed from the exterior of the cell housing, if the closure plate is already fitted to the hollow cylinder. It can thus be prevented that any contaminant particles which might be generated by the formation of electrical connections, for example by a welding process, enter the cell housing.

In some embodiments, the first closure plate is configured in an electrically insulated arrangement from the hollow cylinder. As a result, both the first closure plate and the hollow cylinder can be separately electrically connected, either to the electrode of one polarity or to the electrode of the other polarity.

In some embodiments, the battery cell comprises a second closure plate, which closes the hollow cylinder at a second end face which is opposite the first end face, which comprises a venting mechanism. By means of the venting mechanism, any overpressure which is generated in the battery cell, in particular as a result of a gas which is produced in association with a short-circuiting defect, can be relieved. The venting mechanism preferably comprises a valve.

In some embodiments, the second closure plate comprises an electrolyte inlet. The battery cell can thus be filled with an electrolyte from the exterior of the housing, via the inlet in the second closure plate. It is thus not necessary for the electrolyte filling of the cell housing to be completed prior to the fitting of the first and/or second closure plate of the cell housing. The arrangement of the electrolyte inlet on the opposite side to the electric terminals moreover provides the advantage of greater available space, conversely to the arrangement of the electrolyte inlet on the same side as the electric terminals.

Further advantages, features and potential applications of the present invention proceed from the following detailed description, in conjunction with the figures.

### BRIEF DESCRIPTION OF THE DRAWINGS

FIG. 1 shows a schematic representation of a battery cell, according to a first exemplary embodiment;

FIG. 2 shows a schematic representation of a battery cell, according to a second exemplary embodiment;

FIG. 3 shows a schematic representation of a battery cell according to a third exemplary embodiment;

FIG. 4 shows a schematic representation of a battery cell according to a fourth exemplary embodiment;

FIG. 5 shows a schematic representation of a battery cell according to a fifth exemplary embodiment;

FIG. 6A shows a schematic representation of an electrode winding having a stacking rod, in a cross-sectional view;

FIG. 6B shows a schematic representation of an electrode winding having a stacking rod, in an overhead view;

FIG. 7 shows a schematic representation of a battery cell, according to a sixth exemplary embodiment;

FIG. 8 shows a schematic representation of a battery cell, according to a seventh exemplary embodiment.

In the figures, the same reference numbers are employed throughout for the same, or mutually corresponding elements of the invention.

### DETAILED DESCRIPTION OF THE DRAWINGS

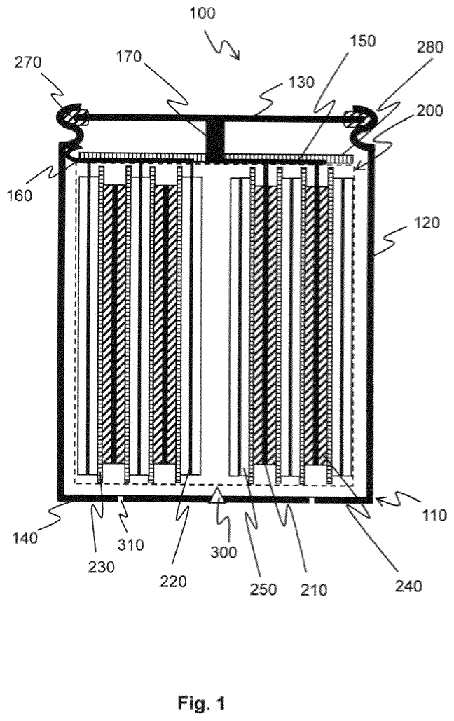

Hereinafter, the battery cell 100 is firstly described, having features which are common to the exemplary embodiments according to FIGS. 1 to 5.

The battery cell 100 comprises a cell housing 110 having an electrically conductive hollow cylinder 120, wherein a first electrically conductive closure plate 130 is arranged at one end face of the hollow cylinder 120, and a second electrically conductive closure plate 140 is arranged at an opposing end face. The first closure plate 130 is arranged in a circular slot, wherein a first electrically insulating element 270 is arranged between the first closure plate 130 and the slot, which electrically insulates the first closure plate 130 vis-à-vis the hollow cylinder 120. The slot opening is oriented in the cylindrical axis of the hollow cylinder 120. The second closure plate 140 is electrically connected to the hollow cylinder 120.

An electrode winding 200 is arranged in the cell housing 110. The electrode winding 200 comprises electrodes having a first positive polarity 210, and electrodes having a second negative polarity 220. However, the electrode winding 200 and the battery cell 100 might also be structured such that the first polarity is negative and the second polarity is positive. The electrode winding 200 is arranged in the cell housing 110 such that, in the radial direction, electrodes of the positive polarity 210 and electrodes of the negative polarity 220 are arranged in an alternating manner. Between electrodes of the positive polarity 210 and electrodes of the negative polarity 220, in each case, a separator 230 is arranged, such that electrodes 210, 220 of different polarities are electrically insulated from one another, wherein the separator comprises an electrically insulating material. On the electrodes of the positive polarity 210, in each case, a first active material 240 is arranged and, on the electrodes of the negative polarity 220, in each case, a second active material 250 is arranged. The electrode winding 200 is arranged within the cell housing 110 such that the negative electrode 220 is electrically connected to the cell housing 110.

It is also conceivable that the electrode winding 200 is arranged within the cell housing 100 in an electrically insulating inner housing (not represented here), which electrically insulates the electrode winding 200 from the cell housing 100. The inner housing can be open at the side of the first closure plate 130 such that, from this side, electrodes can be electrically contact-connected.

Electrodes of the positive polarity 210 are electrically connected to a first electrically conductive contact element 150, which can be a metal plate.

Electrodes of the negative polarity 220 are electrically connected to a second electrically conductive contact element 160, which can be a metal plate.

The second closure plate 140 comprises an electrolyte inlet 300, via which the filling of the cell housing 110 with an electrolyte can be executed. It is also conceivable that the second closure plate 140 does not comprise an electrolyte inlet 300.

The second closure plate 140 comprises a venting mechanism having a venting opening 310, by means of which any potential overpressure in the battery cell 100 can be relieved.

FIG. 1 shows a schematic representation of a battery cell 100 according to a first exemplary embodiment.

Additionally to the above-mentioned features, the first electrically conductive contact element 150 is electrically connected to the first electrically conductive closure plate 130. Between the first electrically conductive contact element 150 and the electrically conductive closure plate 130, moreover, a first electrically conductive adapter 170 is arranged, which electrically and mechanically interconnects the electrically conductive closure plate 130 and the first electrically conductive contact element 150.

The second electrically conductive contact element 160 is electrically connected to the electrically conductive hollow cylinder 120. The first and second electrical contact elements 150, 160, are radially fastened to an electrically insulating fastening element 280, wherein the electrically insulating fastening element 280 is arranged between the first closure plate 130 and the electrical contact elements 150, 160. The first and second electrically conductive contact elements 150, 160 are thus arranged on the same side of the hollow cylinder 120, and the power or voltage of the battery cell 100 can be tapped-off from the same side of the hollow cylinder 120 via the first closure plate 130 and the hollow cylinder 120.

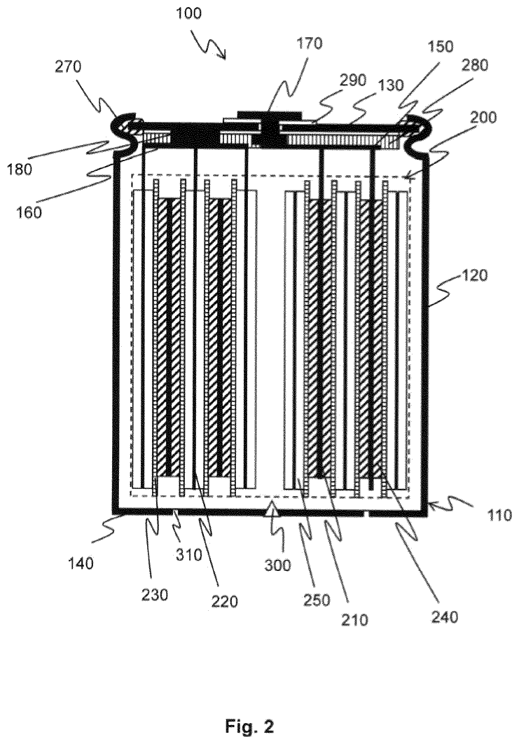

FIG. 2 shows a schematic representation of a battery cell 100 according to a second exemplary embodiment.

Additionally to the above-mentioned features, the first electrically conductive contact element 150 is electrically connected to a first electrically conductive adapter 170, which can be a rivet. The rivet 170 is arranged in an opening in the first closure plate 130 and forms a positive-fitting connection with the first closure plate 130 and with an electrically insulating layer which is arranged between the first closure plate 130 and the rivet. The first closure plate 130 is configured in an electrically insulated arrangement vis-à-vis the first electrically conductive adapter 170 and the first electrically conductive contact element 150. The second electrically conductive contact element 160 is electrically connected to the first electrically conductive closure plate 130. A second electrically conductive adapter 180 is arranged between the closure plate 130 and the second adapter 180 and is respectively electrically connected to the second electrically conductive contact element 160 and to the first closure plate 130. The voltage of the battery cell 100 can thus be tapped from one side, via the first closure plate 130 and the first adapter 170.

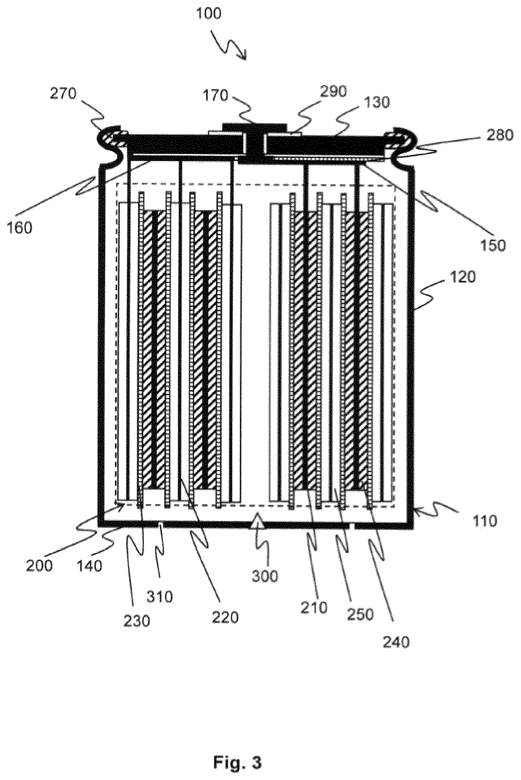

FIG. 3 shows a schematic representation of a battery cell 100 according to a third exemplary embodiment.

By way of distinction from the second exemplary embodiment, the first closure plate 130 in this third exemplary embodiment assumes a greater thickness, and is directly connected to the second electrically conductive contact element 160. The second electrically conductive contact element 160 thus comprises a laterally arranged web, which extends axially in the direction of the first closure plate 130 and is laterally secured to the latter.

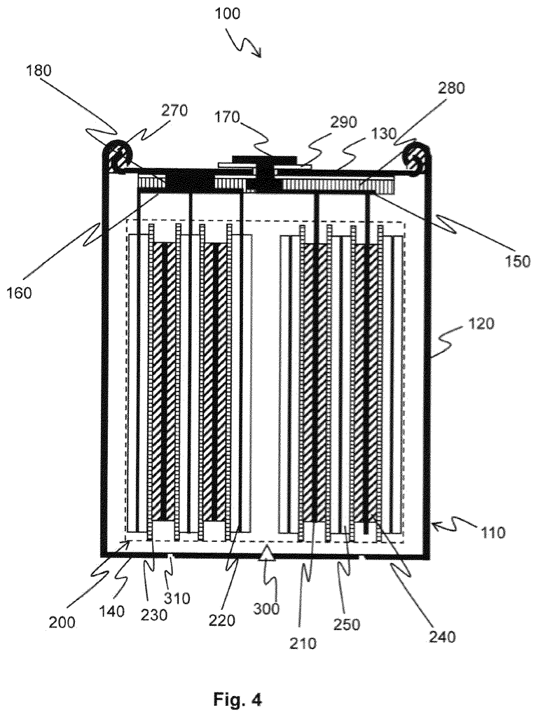

FIG. 4 shows a schematic representation of a battery cell 100 according to a fourth exemplary embodiment.

By way of distinction from the preceding exemplary embodiments, the slot opening is essentially oriented in a parallel direction to the cylindrical axis of the hollow cylinder 110. In this exemplary embodiment, the first closure plate 130 comprises a circumferential element which projects outwardly from the closure plate and which engages in the slot, wherein a first insulating element is arranged between the slot and the outwardly-projecting element.

FIG. 5 shows a schematic representation of a battery cell 100 according to a fifth exemplary embodiment.

By way of distinction from the second exemplary embodiment, the slot opening is essentially oriented in a parallel direction to the cylindrical axis of the hollow cylinder 110. In this exemplary embodiment, the first closure plate 130 comprises a circumferential element which projects outwardly from the closure plate and which engages in the slot, wherein a first insulating element is arranged between the slot and the outwardly-projecting element. The second electrically conductive contact element 160 comprises a region which projects in the direction of a hollow cylinder wall, at a shallow angle, and is electrically connected to the first closure plate 130.

In the exemplary embodiments according to FIGS. 2 to 5, in each case, it is provided that the electrode of the second polarity 220, which can be negative, is electrically insulated by the first electrical insulating element 270 vis-à-vis the cell housing 110. In the above-mentioned exemplary embodiments, it is also conceivable that the first electrical insulating element 270 at least assumes a lower electrical conductivity, the value of which lies between the electrical conductivity, for example, of a metallic electrical conductor and that of an electrical insulator such as, for example, a polymer or a polymer compound incorporating industrial soot, also known as carbon black. By increasing the carbon black component of the polymer compound, electrical conductivity can be increased. The electrical conductivity of the first electrical insulating elements 270 should be at least sufficiently high such that a low current can flow between the, in particular, negative electrode 210 and the cell housing 110, as a result of which a negative polarity of the cell housing 110 is generated. Corrosion of the cell housing 110 can thus be at least reduced or slowed down. At the same time, the electrical resistance of the first electrical insulating element 270 should be sufficiently high, such that a short-circuit, for example between two adjoining cell housings 110, can be prevented. In the event that two adjoining cell housings assume different voltages, and condensed water enters into contact with both cell housings, this water might be oxidized, thereby resulting in the release of hydrogen and oxygen. This process might also be prevented, or at least attenuated in the event that, although the cell housing 110 assumes a negative polarity, this polarity is generated by a low current, and the electrical insulating element 270 through which the current flows assumes a sufficiently high resistance.

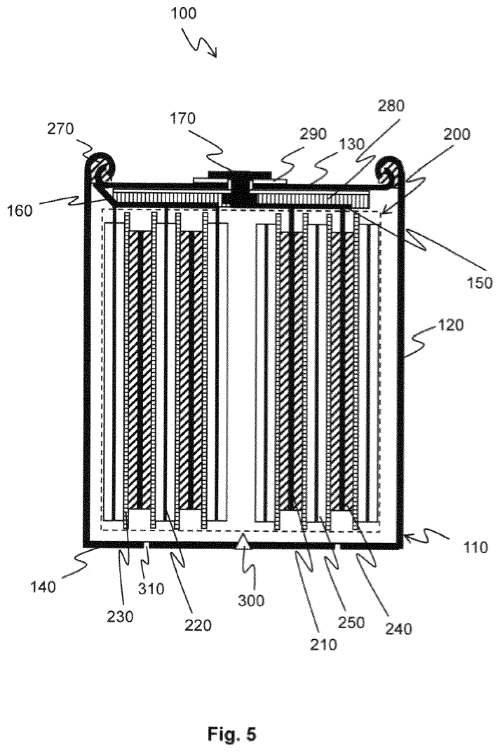

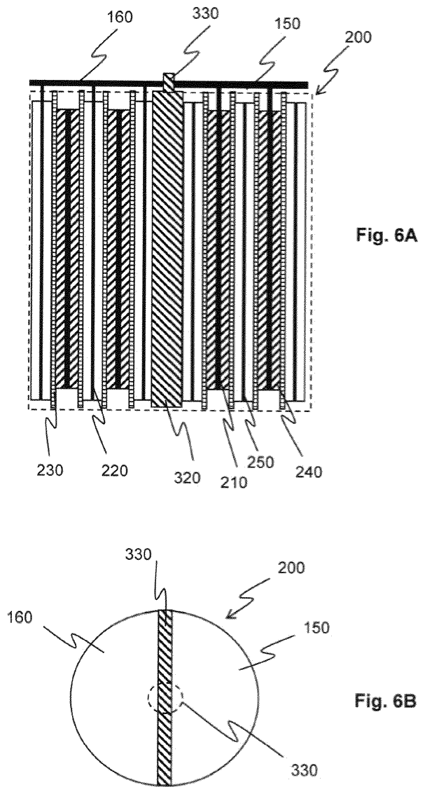

FIG. 6A shows a schematic representation of an electrode winding 200 having a stacking rod 320, in a cross-sectional view. The electrode winding 200 is wound about the stacking rod 320, wherein the stacking rod 320 comprises an electrically insulating material, in particular a plastic. By means of the stacking rod 320, the electrode winding 200 is axially stabilized. At one end of the stacking rod 320, the stacking rod 320 comprises an insulating spacer element 330, which insulates the first 150 and second 160 electrically conductive contact elements from one another. The stacking rod 320 thus functions as a fastening element or carrier element for the electrically insulating spacer element 330, such that it is not necessary for the latter to be fastened to one or both electrically insulating contact elements 150, 160. The stacking rod 320 and the electrically insulating spacer element 330 can also be integrally configured as a single unit.

FIG. 6B shows a schematic representation of an electrode winding 200 having a stacking rod 320, in an overhead view. The first electrically conductive contact element 150 and the second electrically conductive contact element 160 respectively form a half-circle of surface area. The insulating spacer element 330 extends over the diameter of the half-circle.

The stacking rod 320 and the electrically insulating spacer element 330 can respectively be integrated in the above-mentioned embodiments.

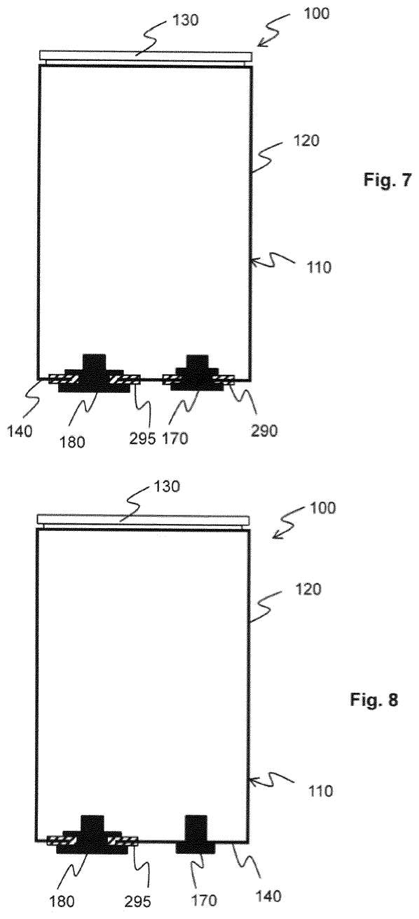

FIG. 7 shows a schematic representation of a battery cell 100 according to a sixth exemplary embodiment, in particular the electrical connections thereof, which can be electrically contact-connected from the exterior of the battery cell 100.

The battery cell 100 comprises a cell housing 110 having an electrically conductive hollow cylinder 120 wherein, on the two opposing end faces of the hollow cylinder 120, a first electrically conductive closure plate 130 and a second electrically conductive closure plate 140 are arranged. The second closure plate 140 comprises two openings. In one opening, a first electrically conductive adapter 170 and, in the other opening, a second electrically conductive adapter 180 are arranged. The first and second electrically conductive adapters 170, 180 respectively comprise a rivet. The rivets, vis-à-vis the second closure plate 140, are insulated by a second or third insulating element 290, 295. In the cell housing 110, an electrode winding 200 can be arranged, as described in FIGS. 1 to 6B. The two rivets 170, 180 are electrically connected, either to the electrodes of one polarity or to the electrodes of the other polarity of the electrode winding 200. As a result, the voltage of the battery cell can be tapped-off from the exterior of the cell housing 110 via the first and second rivets.

FIG. 8 shows a schematic representation of a battery cell 100 according to a seventh exemplary embodiment.

By way of distinction from the sixth exemplary embodiment, in the present exemplary embodiment, the first electrically conductive adapter 170 is electrically connected to the second closure plate 140.

### LIST OF REFERENCE NUMBERS

100 Battery cell
110 Cell housing
120 Hollow cylinder
130 First closure plate
140 Second closure plate
150 First electrically conductive contact element
160 Second electrically conductive contact element
170 First electrically conductive adapter
180 First electrically conductive adapter
200 Electrode winding
210 Electrodes of the first (positive) polarity
220 Electrodes of the second (negative) polarity
230 Separator
240 First active layers
250 Second active layers
270 First insulating element
280 Electrically insulating fastening element
290 Second insulating element
295 Third insulating element
300 Electrolyte inlet
310 Venting opening
320 Stacking rod
330 Insulating spacer element

1.-12. (canceled)

13. A battery cell, comprising:
a cell housing having an electrically conductive hollow cylinder;
an electrode of a first electrical polarity and an electrode of a second electrical polarity, which is opposite to the first polarity, wherein the electrodes of different polarities are mutually separated by a separator;
a first electrically conductive contact element which is electrically connected to the electrode of the first polarity, and which can be contact-connected as a first pole of the battery cell from outside the cell housing;
a second electrically conductive contact element which is electrically connected to the electrode of the second polarity, and which can be contact-connected as a second pole of the battery cell from outside the cell housing;
wherein the first and second electrically conductive contact elements are electrically insulated from one another and, on a same first end face of the electrically conductive hollow cylinder, can each be contact-connected as a respective pole from outside the cell housing.

14. The battery cell according to claim 13, wherein
an electrical insulation between the first and second electrically conductive contact elements is configured by means of a radial spacing between the first and second electrically conductive contact elements, with respect to an axis of symmetry of the hollow cylinder.

15. The battery cell according to claim 14, wherein
in an interspace formed by a radial spacing, a spacer element is arranged, which comprises an electrically insulating material.

16. The battery cell according to claim 13, further comprising:
an electrically insulating fastening element to which the first and second electrically conductive contact elements are fastened,
wherein the electrically insulating fastening element is arranged between the first end face of the electrically conductive hollow cylinder and the two electrically conductive contact elements.

17. The battery cell according to claim 13, further comprising:
an electrically conductive first closure plate, which closes the hollow cylinder at its first end face, wherein the first closure plate is electrically connected to the first electrically conductive contact element.

18. The battery cell according to claim 13, further comprising:
an electrically conductive first closure plate, which closes the hollow cylinder at its first end face, having a first opening, in which a first electrically conductive adapter is arranged, such that it can be electrically contact-connected from outside the cell housing,
wherein the first electrically conductive adapter is electrically connected to the first electrically conductive contact element, and wherein the first electrically conductive adapter is electrically insulated from the first closure plate.

19. The battery cell according to claim 13, wherein
the second electrically conductive contact element is electrically connected to the electrically conductive hollow cylinder.

20. The battery cell according to claim 13, wherein
the second electrically conductive contact element is directly electrically connected to the electrically conductive first closure plate.

21. The battery cell according to claim 18, wherein
the electrically conductive first closure plate comprises a second opening, in which a second electrically conductive adapter is arranged, such that it can be electrically contact-connected from outside the cell housing, and
the second electrically conductive adapter is electrically connected to the second electrically conductive contact element, and wherein the second electrically conductive adapter is electrically insulated from the first closure plate.

22. The battery cell according to claim 13, wherein
the first closure plate is configured in an electrically insulated arrangement from the hollow cylinder.

23. The battery cell according to claim 13, further comprising:
a second closure plate at a second end face which is opposite the first end face, which comprises a venting mechanism.

24. The battery cell according to claim 13, wherein
the second closure plate comprises an electrolyte inlet.
